(19) United States
(12) Patent Application Publication
(10) Pub. No.: US 2017/0295471 A1
(43) Pub. Date: Oct. 12, 2017

(54) ACCESS POINT IN GEOGRAPHIC ROUTING SYSTEM AND CONTROLLING METHOD THEREOF

(71) Applicant: INDUSTRIAL TECHNOLOGY RESEARCH INSTITUTE, Hsinchu (TW)

(72) Inventors: Tien-Yuan HSIEH, Taoyuan City (TW); Po-Chun KANG, Zhudong Township (TW); Chia-Chang HSU, Taoyuan City (TW); Lo-Chuan HU, Zhudong Township (TW)

(73) Assignee: INDUSTRIAL TECHNOLOGY RESEARCH INSTITUTE, Hsinchu (TW)

(21) Appl. No.: 15/093,721

(22) Filed: Apr. 7, 2016

(51) Int. Cl. H04W 4/06; H04W 40/20; H04W 52/22

(52) U.S. Cl. CPC H04W 4/06; H04W 52/228; H04W 40/20

(57) ABSTRACT

An access point in a geographic routing system and a controlling method thereof are provided. The controlling method of the access point in the geographic routing includes the following steps. A traffic event packet is received by the access point. A back-off timer of the access point is set to be a first back-off time value. The first back-off time value is less than a second back-off time value of any on board unit (OBU) which receives the traffic event packet. The traffic event packet is broadcasted by the access point when the back-off timer is counted down to be zero.

### TECHNICAL FIELD

The disclosure relates in general to an electronic device and a controlling method thereof, and an access point in a geographic routing system and a controlling method thereof.

### BACKGROUND

The intelligent transportation system (ITS) is a system for monitoring and managing the transportation via the electronics, software, communication and controlling technology. The European Telecommunication Standards Institute (ETSI) defines some protocols, such as GeoNetworking Forwarding Algorithm, for the ITS.

In the geographic routing system, when a car moves through and detects an uneven area on a road, an on board unit (OBU) on the car will broadcast a traffic event packet to inform other cars to notice the uneven area. The OBU on this car will periodically broadcast the traffic event packets.

In lower traffic flow, when the OBU on this car broadcasts the traffic event packets, the traffic event packets may not be received by any other car because there is no car located in the transmitting range of the OBU. Further, this car will go away the uneven area and cannot be kept at the uneven area to broadcast the traffic event packets. Therefore, the efficiency of the traffic event diffusion is low and is needed to be improved.

### SUMMARY

The disclosure is directed to an access point in a geographic routing system and a controlling method thereof.

According to one embodiment, a controlling method of an access point in a geographic routing system is provided. The controlling method of the access point in the geographic routing includes the following steps. A traffic event packet is received by the access point. A back-off timer of the access point is set to be a first back-off time value. The first back-off time value is less than a second back-off time value of any on board unit (OBU) which receives the traffic event packet. The traffic event packet is broadcasted by the access point when the back-off timer is counted down to be zero.

According to another embodiment, a controlling method of an access point in a geographic routing system is provided. The controlling method of the access point in the geographic routing includes the following steps. A traffic event packet is received by the access point. Whether there is another access point which is closer to a destination area than the access point is determined. The traffic event packet is forwarded to the another access point, if there is the another access point which is closer to the destination area than the access point. The traffic event packet is also broadcasted by the access point.

According to an alternative embodiment, an access point in a geographic routing system is provided. The access point in the geographic routing system includes a transmitter and a processor. The transmitter receives a traffic event packet and transmits the traffic event packet when a back-off timer of the access point is counted down to be zero. The processor sets a back-off timer of the access point to be a first back-off time value. The first back-off time value is less than a second back-off time value of any on board unit (OBU) which receives the traffic event packet.

According to another embodiment, an access point in a geographic routing system is provided. The access point in the geographic routing system includes a transmitter, a location provider and a processor. The transmitter receives a traffic event packet and transmits the traffic event packet when a back-off timer of the access point is counted down to be zero. The location provider provides a location of the access point. The processor determines whether there is another access point which is closer to a destination area than the access point according to the location of the access point. The transmitter forwards the traffic event packet to the another access point, if there is the another access point which is closer to the destination area than the access point.

### BRIEF DESCRIPTION OF THE DRAWINGS

FIG. 1 shows a block diagram of an access point in a geographic routing system.

FIG. 2 shows a block diagram of an on board unit (OBU) on a car in the geographic routing system.

FIG. 3A to 3B illustrate a controlling method in the geographic routing system according to one embodiment.

FIGS. 4A to 4B illustrate a controlling method in the geographic routing system according to one embodiment.

FIG. 5A to 5B illustrate a controlling method in the geographic routing system according to one embodiment.

FIGS. 6A to 6B illustrate a controlling method in the geographic routing system according to one embodiment.

FIGS. 7A to 7B show a flow chart of a controlling method of the access point in the geographic routing system according to one embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

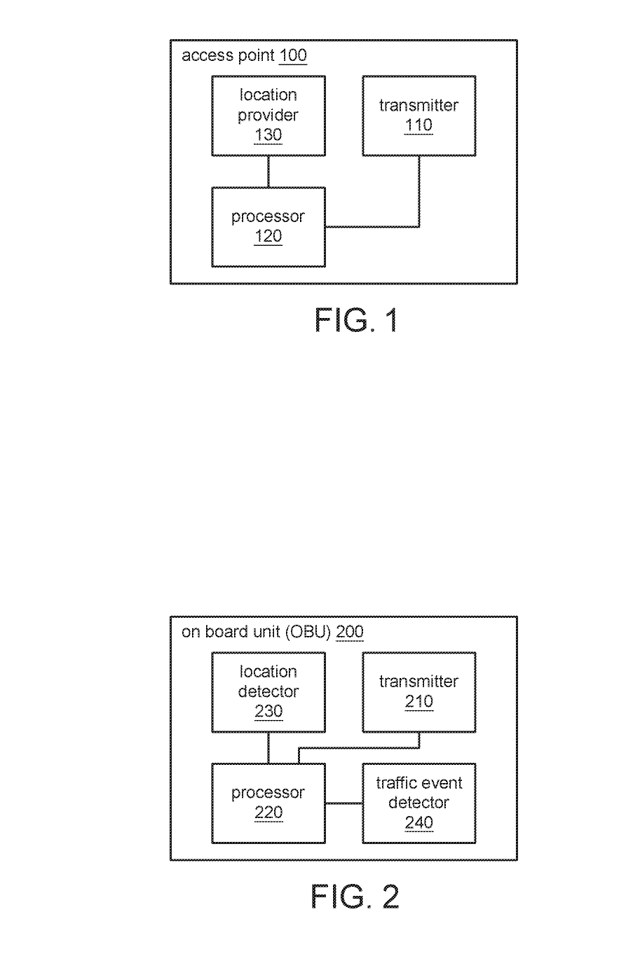

Please refer to FIGS. 1 to 2. FIG. 1 shows a block diagram of an access point 100 in a geographic routing system. FIG. 2 shows a block diagram of an on board unit (OBU) 200 on a car in the geographic routing system. Referring to FIG. 1, the access point 100 includes a transmitter 110, a processor 120 and a location provider 130. The transmitter 110 is used for transmitting signals. For example, the transmitter 110 can be a wireless transmitting module or a communication line. The processor 120 is used for performing an analyzing procedure, a calculating procedure or a controlling procedure. For example, the processor 120 can be a chip, a circuit board or a computer. The location provider 130 is used for providing a location of the access point 100. Because the access point 100 is disposed on a fixed stand and will not move, the location is fixed and can be previously recorded. For example, the location provider 130 can be a storage device, such as a hard disk, a memory or a memory card. Or, the location provider 130 can be a GPS information receiver.

Referring to FIG. 2, the OBU 200 includes a transmitter 210, a processor 220, a location detector 230 and a traffic event detector 240. The transmitter 210 is used for transmitting signals. For example, the transmitter 210 can be a wireless transmitting module. The processor 220 is used for performing an analyzing procedure, a calculating procedure or a controlling procedure. For example, the processor 220 can be a chip, a circuit board, a computer or a smart phone. The location detector 230 is used for detecting a position of the OBU 200. The location detector 230 can be a GPS information receiver. The traffic event detector 240 is used for detecting a traffic event. The traffic event detector 240 can be a vibration detector, and the traffic event is detected according to a vibration of the car.

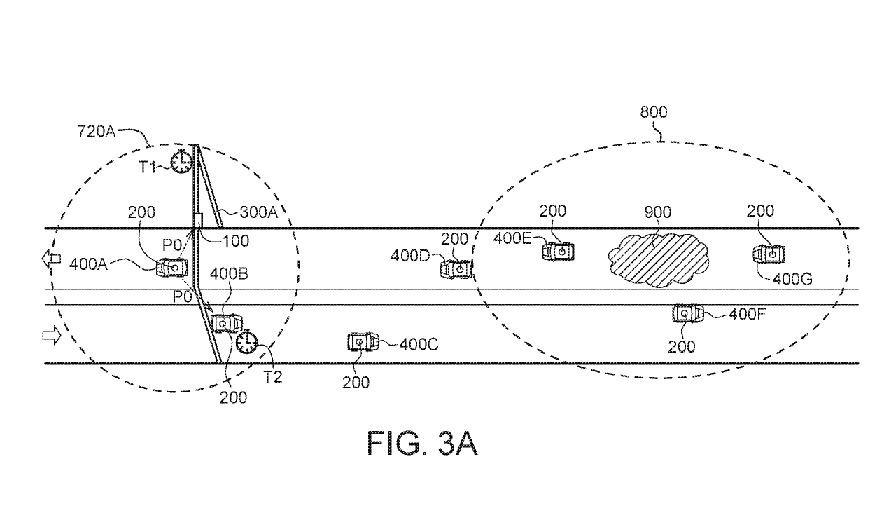

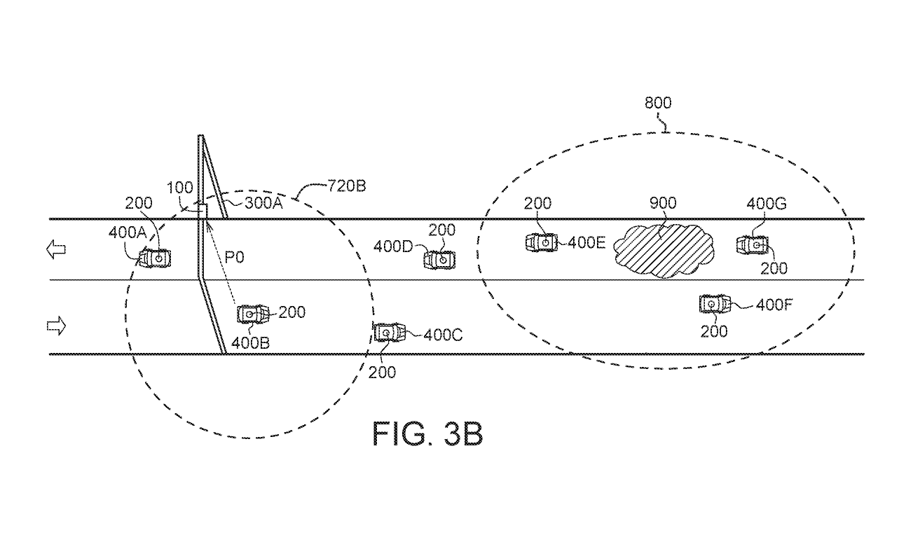

Please refer to FIG. 3A to 3B, which illustrate a controlling method in the geographic routing system according to one embodiment. Referring to FIG. 3A, one access point 100 is fixed on a stand 300A, and seven OBUs 200 are disposed on cars 400A to 400G respectively. After the OBU 200 on the car 400A moved through and detected an uneven area 900, the OBU 200 on the car 400A periodically broadcasts a traffic event packet P0.

Referring to FIG. 3A, the access point 100 on the stand 300A and the OBU 200 on the car 400B are located in a transmitting range 720A of the OBU 200 on the car 400A. The access point 100 on the stand 300A and the OBU 200 on the car 400B receive the traffic event packet P0. The access point 100 on the stand 300A sets a back-off timer T1 and the OBU 200 on the car 400B sets a back-off timer T2. In the embodiment of FIGS. 3A to 3B, a second back-off time value of the back-off timer T2 is less than a first back-off time value of the back-off timer T1, because the car 400B is closer to a destination area 800 than the stand 300A.

For example, the back-off timer can be set according to the following equation (1). Def_{Min} is a predetermined minimum time value, and Def_{Max} is a predetermined maximum time value. Distance(A,B) is a function for calculating a distance between A and B. Fwd is the node to be broadcasted, such as the access point 100 on the stand 300A and the OBU 200 on the car 400B. Dst is the center of the destination area 800. Src is the node that first broadcasts the traffic event packet, such as the OBU 200 on the car 400A. According to the equation (1), the car 400B is closer to the destination area 800 than the stand 300A, so the second back-off time value of the back-off timer T2 is less than the first back-off time value of the back-off timer T1.

$$Timer = \{ \begin{matrix}\begin{matrix}{Def}_{Min} + \frac{{Def}_{Max} - {Def}_{Min}}{{Def}_{Max}} \times \\ Distance ( Fwd , Dst ) ,\end{matrix} & \begin{matrix}if Distance ( Fwd , Dst ) < \\ Distance ( Src , Dst )\end{matrix} \\ {Def}_{Max} , & \begin{matrix}if Distance ( Fwd , Dst ) > \\ Distance ( Src , Dst )\end{matrix}\end{matrix} \qquad ( 1 )$$

Referring to FIG. 3B, the traffic event packet P0 will be broadcasted again if the back-off timer T1 or T2 is counted down to be zero. Because the second back-off time value of the back-off timer T2 is less than the first back-off time value of the back-off timer T1, the OBU 200 on the car 400B will broadcast the traffic event packet P0 first. The traffic event packet P0 will be sent to the access point 100 on the stand 300A which is located within a transmitting range 720B of the OBU 200 on the car 400B.

When the access point 100 on the stand 300A receives the traffic event P0 secondly, the back-off timer T1 will be frozen and thrown. Hence, the access point 100 on the stand 300A will not broadcast the traffic event packet P0, again.

However, because the OBU 200 on the car 400C is not located within the transmitting range 720B of the OBU 200 on the car 400B, the traffic event packet P0 cannot be sent to the OBU 200 on the car 400C. Therefore, in the embodiment in FIGS. 3A and 3B, the traffic even packet P0 cannot be kept delivering toward the destination area 800.

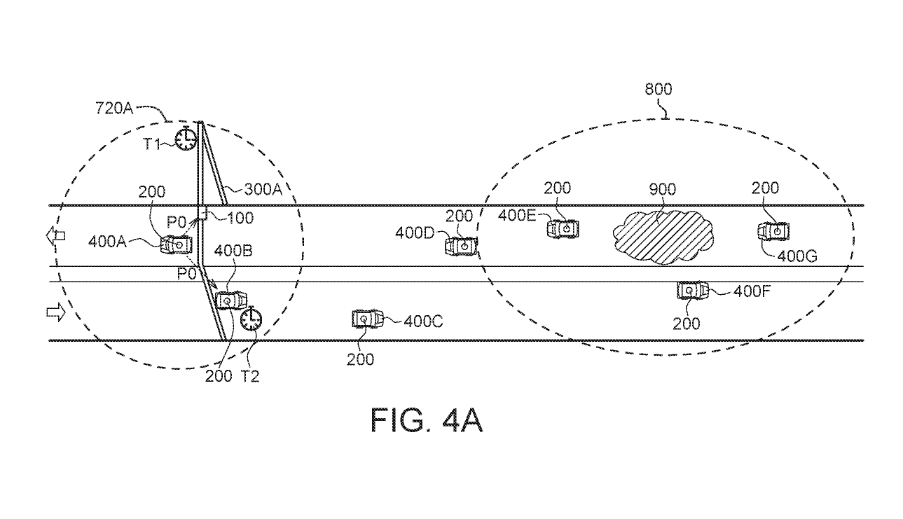

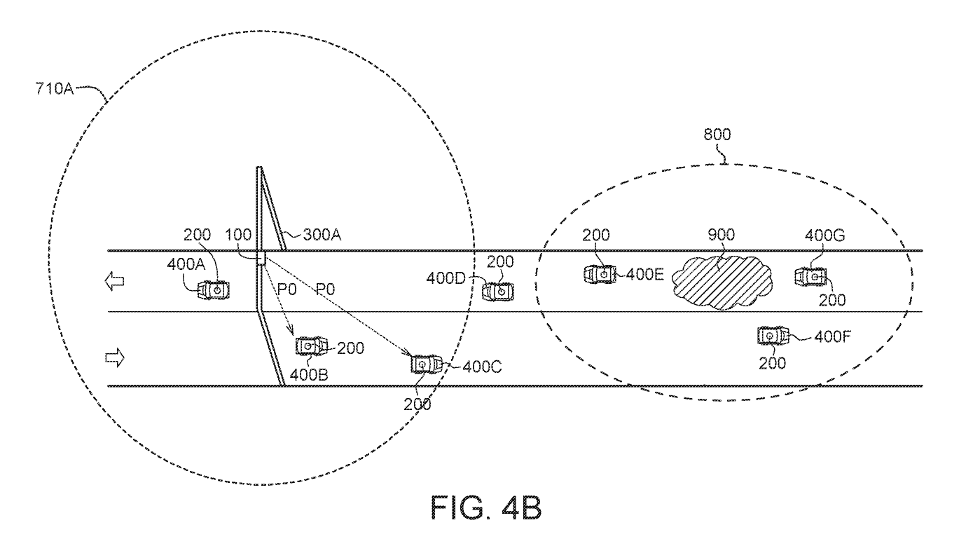

Please refer to FIGS. 4A to 4B, which illustrate a controlling method in the geographic routing system according to one embodiment. Referring to FIG. 4A, after the OBU 200 on the car 400A moved through and detected the uneven area 900, the OBU 200 on the car 400A periodically broadcasts the traffic event packet P0.

Referring to FIG. 4A, the access point 100 on the stand 300A and the OBU 200 on the car 400B are located in the transmitting range 720A of the OBU 200 on the car 400A. The access point 100 on the stand 300A and the OBU 200 on the car 400B receive the traffic event packet P0. The access point 100 on the stand 300A sets the back-off timer T1 and the OBU 200 on the car 400B sets the back-off timer T2.

In this embodiment, the first back-off time value of the back-off timer T1 is set to be less than the second back-off time value of the back-off timer T2 of any OBU 200 which receives the traffic event packet P0. For example, according to the equation (2), the first back-off time value is the predetermined minimum time value, such as zero.

$$Timer = \{ \begin{matrix}\begin{matrix}{Def}_{Min} + \frac{{Def}_{Max} - {Def}_{Min}}{{Def}_{Max}} \times \\ Distance ( Fwd , Dst ) ,\end{matrix} & \begin{matrix}if Distance ( Fwd , Dst ) < \\ Distance ( Src , Dst )\end{matrix} \\ {Def}_{Max} , & \begin{matrix}if Distance ( Fwd , Dst ) > \\ Distance ( Src , Dst )\end{matrix} \\ {Drf}_{Min} , & if Fwd = access point\end{matrix} \qquad ( 2 )$$

That is to say, the access point 100 on the stand 300A will broadcast first, even if the stand 300A is farther to the destination area 800 than the car 400B. Thus, by setting the back-off timer of the access point 100 to be the first back-off time value which is lower than the second back-off time value of the OBU 200, the access point 100 has a high priority to broadcast the traffic event packet P0.

Further, the transmitting power of the access point 100 is set to be a first transmitting power value. The first transmitting power value is larger than a second transmitting power value of any OBU 200. For example, the first transmitting power value is a predetermined maximum power value. Referring to FIG. 4B, because the first transmitting power value is large, a transmitting range 710A may cover the OBU 200 on the car 400C. Therefore, the traffic event packet P0 can be sent to the OBU 200 on the car 400C and the traffic event packet P0 can be kept delivering toward the destination area 800.

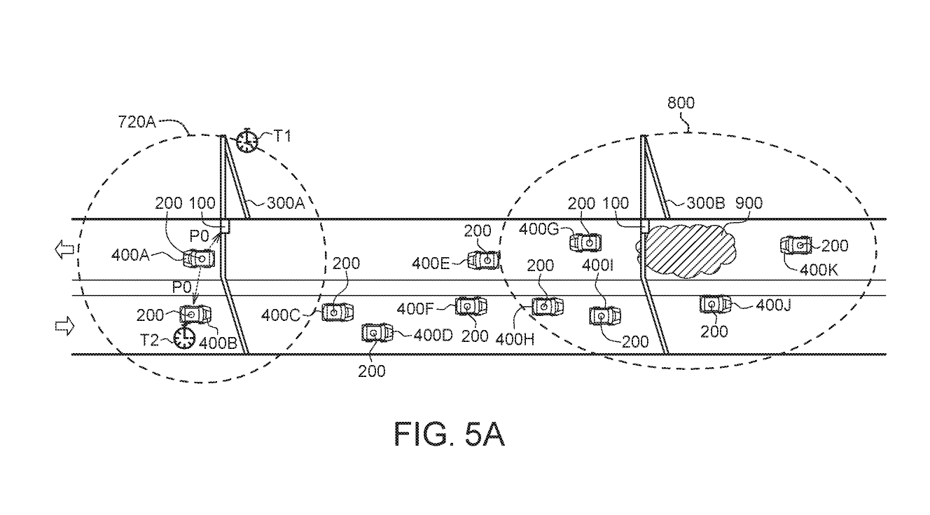

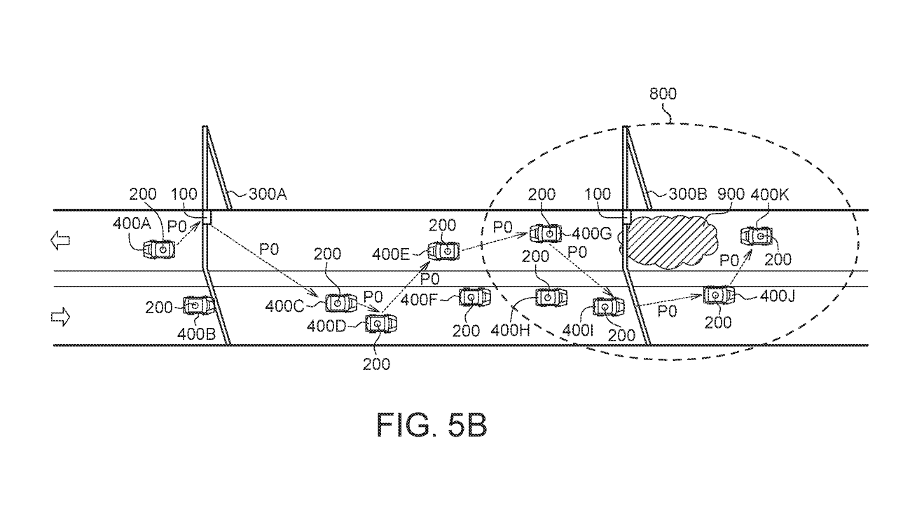

Further, please refer to FIG. 5A to 5B, which illustrate a controlling method in the geographic routing system according to one embodiment. Referring to FIG. 5A, after the OBU 200 on the car 400A moved through and detected the uneven area 900, the OBU 200 on the car 400A periodically broadcasts the traffic event packet P0.

Referring to FIG. 5A, the access point 100 on the stand 300A and the OBU 200 on the car 400B are located in the transmitting range 720A of the OBU 200 on the car 400A. The access point 100 on the stand 300A and the OBU 200 on the car 400B receive the traffic event packet P0. The access point 100 on the stand 300A sets the back-off timer T1 and the OBU 200 on the car 400B sets the back-off timer T2. In the embodiment of FIGS. 5A to 5B, because the stand 300A is closer to the destination area 800 than the car 400B, the first back-off time value of the back-off timer T1 is less than the second back-off time value of the back-off timer T2.

The traffic event packet P0 will be broadcasted again if the back-off timer T1 is counted down to be zero. The access point 100 on the stand 300A will broadcast the traffic event packet P0 to the OBU 200 on the car 400C.

Referring to FIG. 5B, to inform the car 400K, the traffic event packet P0 may be transmitted toward the destination area 800 via the OBU 200 on the car 400A, the access point 100 on the stand 300A, the OBU 200 on the car 400C, the OBU 200 on the car 400D, the OBU 200 on the car 400E, the OBU 200 on the car 400G, the OBU 200 on the car 400I, the OBU 200 on the car 400J, and the OBU 200 on the car 400K sequentially.

In the embodiment of FIGS. 5A to 5B, a hop limit value is set to be a predetermined count value initially. The hop limit value is decreased by 1 when the traffic event packet P0 is transmitted one time. When the hop limit value is decreased to zero, then the traffic event packet P0 will be thrown away. Therefore, the number of transmitting times of the traffic event packet P0 can be limited within the predetermined count value.

However, for informing the uneven area 900 to the car 400K, the traffic event packet P0 is transmitted via several OBUs 200 on several cars. The transmission of the traffic event packet P0 spends a lot of time.

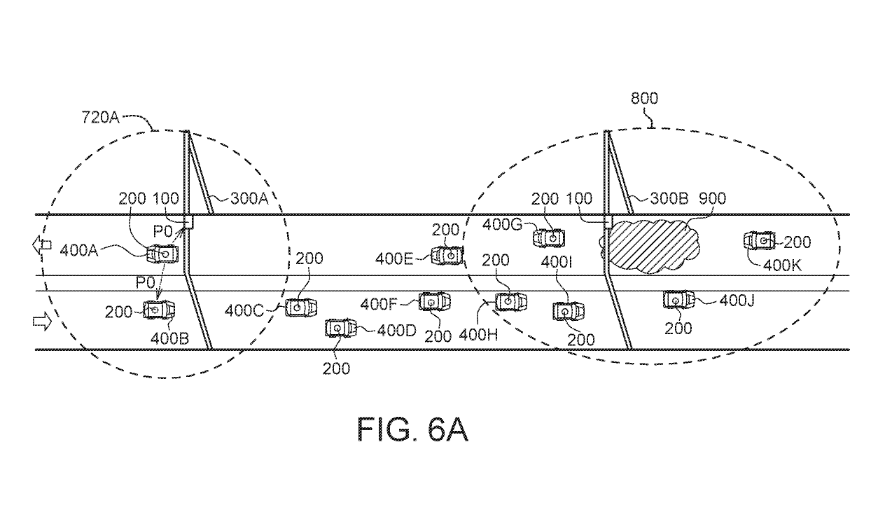

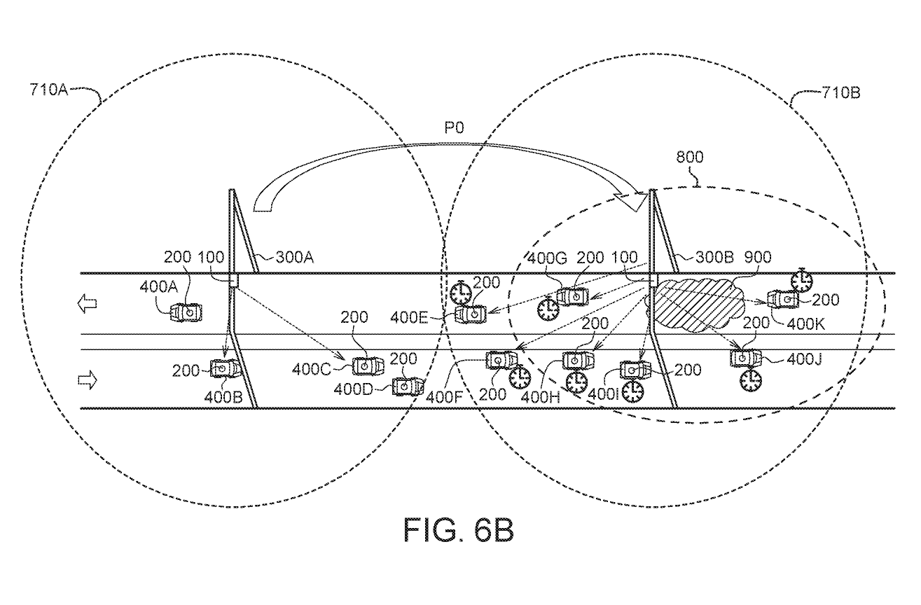

Please refer to FIGS. 6A to 6B, which illustrate a controlling method in the geographic routing system according to one embodiment. Referring to FIG. 6A, after the OBU 200 on the car 400A moved through and detected the uneven area 900, the OBU 200 on the car 400A periodically broadcasts the traffic event packet P0.

Referring to FIG. 6A, the access point 100 on the stand 300A and the OBU 200 on the car 400B are located in the transmitting range 720A of the OBU 200 on the car 400A. The access point 100 on the stand 300A and the OBU 200 on the car 400B receive the traffic event packet P0. The access point 100 on the stand 300A sets the back-off timer T1 and the OBU 200 on the car 400B sets the back-off timer T2.

Referring to FIG. 6B, the access point 100 on the stand 300A finds that there is another access point 100 on the stand 300B which is closer to the destination area 800 than the access point 100 on the stand 300A. Then, the access point 100 on the stand 300A directly forwards the traffic event packet P0 to the access point 100 on the stand 300B. Therefore, the traffic event packet P0 can be sent to the OBUs 200 on the cars 400E to 400K which are close to the destination area 800. Therefore, to inform the car 400K, the traffic event packet P0 is transmitted via the OBU 200 on the car 400A, the access point 100 on the stand 300A, the access point 100 on the stand 300B and the OBU 200 on the car 400K sequentially. Thus, transmission of the traffic event packet P0 spends less time.

Furthermore, after the access point 100 on the stand 300A found the access point 100 on the stand 300B which is closer to the destination area 800, the traffic event packet P0 not only be forwarded to the access point 100 on the stand 300B, but also be broadcasted by the access point 100 on the stand 300A. In the embodiment of FIGS. 6A to 6B, when the traffic event packet P0 is broadcasted, the hop limit value is set to be a predetermined minimum count value, such as 1. Therefore, after the OBU 200 on the car 400B or the OBU 200 on the car 400C receives the traffic event packet P0, the hop limit value will be decreased to be zero, and the traffic event packet P0 will be thrown away. Therefore, the traffic event packet P0 will not be broadcast from the access point 100 on the stand 300A.

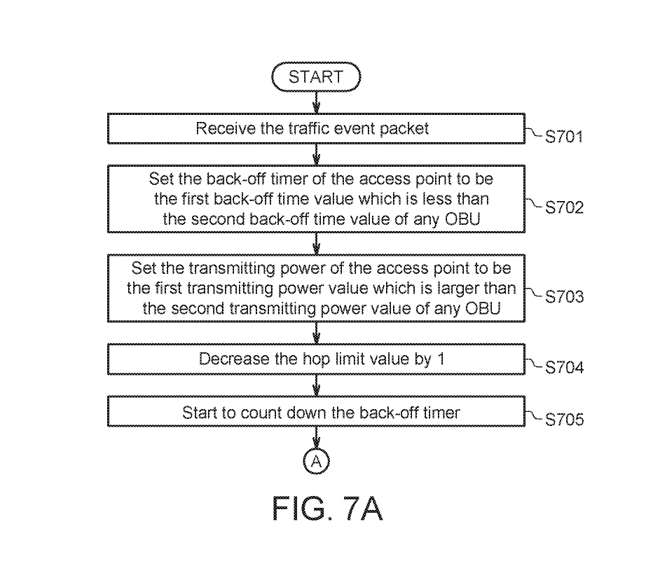

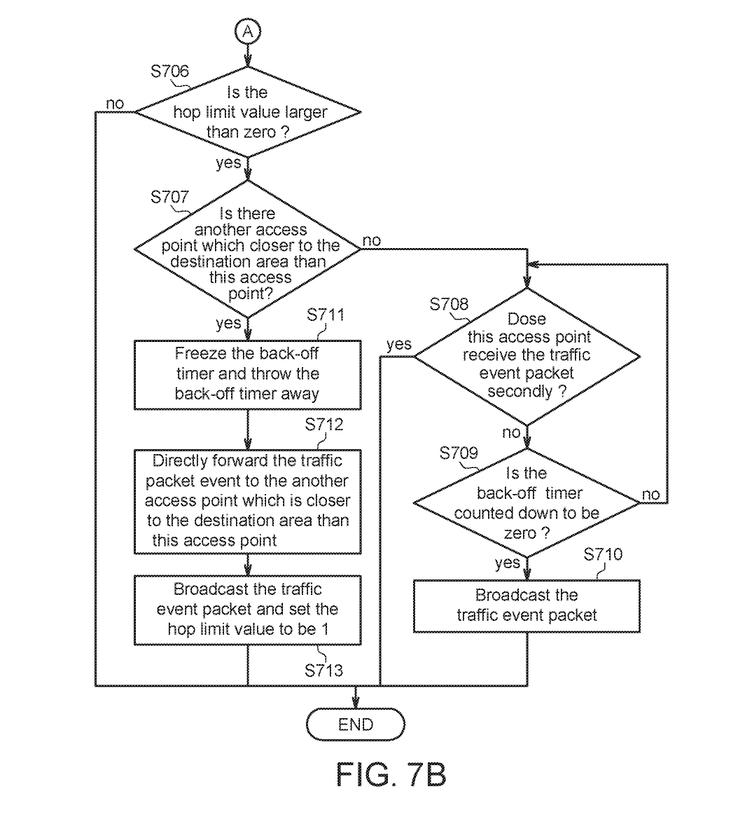

In the embodiments described above, the transmitting efficiency of the traffic event packet P0 can be improved by setting the back-off timer, setting the transmitting power, setting the hop limit value, or directly forwarding the traffic event packet P0 to another access point 100. Please refer to FIGS. 7A to 7B, which show a flow chart of a controlling method of the access point 100 in the geographic routing system according to one embodiment. This flowchart in FIGS. 7A to 7B is just one example to practice the designs described above. The sequence of those steps is not limited thereto. In some embodiment, the order of some steps can be changed, or some steps can be omitted. For illustrating the operation of the access point 100, the controlling method is illustrated by the access point 100 in FIG. 1.

In step S701, the transmitter 110 of the access point 100 receives the traffic event packet P0.

In step S702, the processor 120 of the access point 100 sets the back-off timer of the access point 100 to be the first back-off time value which is less than the second back-off time value of any OBU 200. Therefore, the priority of the access point 100 can be higher than the priority of the OBU 200.

In step S703, the processor 120 of the access point 100 sets the transmitting power of the access point 100 to be the first transmitting power value which is larger than the second transmitting power value of any OBU 200. Therefore, the transmitting range of the access point 100 can be enlarged for sending to more OBUs 200 (or more access points 100).

In step S704, the processor 120 of the access point 100 decreases the hop limit value by 1. The hop limit value is used to limit the number of transmitting times of the traffic event packet P0.

In step S705, the processor 120 starts to count down the back-off timer.

In step S706, the processor 120 determines whether the hop limit value is larger than zero or not. If the hop limit value is larger than zero, then the process proceeds to step S707; if the hop limit value is not larger than zero, then the process is terminated.

In step S707, the processor 120 determines whether there is another access point 100 which is closer to the destination area 800 than this access point 100. If there is another access point 100 which is closer to the destination area 800 than this access point 100, then the process proceeds to step S711; if there is no access point 100 which is closer to the destination area 800 than this access point 100, then the process proceeds to step S708.

In step S708, the processor 120 of the access point 100 determines whether this access point 100 receives the traffic event packet P0 secondly or not. If this access point 100 receives the traffic event packet P0 secondly, then the process is terminated; if this access point 100 does not receive the traffic event packet P0 secondly, then the process proceeds to step S709.

In step S709, the processor 120 of the access point 100 determines whether the back-off timer is counted down to be zero. If the back-off timer is counted down to be zero, then the process proceeds to step S710; if the back-off timer is not counted down to be zero, then the process proceeds to step S708.

In step S710, the transmitter 110 of the access point 100 broadcasts the traffic event packet P0.

If there is another access point 100 which is closer to the destination area 800 than this access point 100, then the process proceeds to step S711.

In step S711, the processor 120 of the access point 100 freeze the back-off timer and throws the back-off timer away.

In step S712, the transmitter 110 of the access point 100 directly forwards the traffic event packet P0 to another access point 100 which is closer to the destination area 800 than this access point 100.

In step S713, the transmitter 110 of the access point 100 broadcasts the traffic event packet P0 and the processor 120 of the access point 100 set the hop limit value to be 1.

According to the embodiments described above, the transmitting efficiency of the traffic event packet P0 can be improved by setting the back-off timer, setting the transmitting power, setting the hop limit value, or directly forwarding the traffic event packet P0 to another access point 100.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A controlling method of an access point in a geographic routing system, comprising:
receiving a traffic event packet by the access point; and
setting a back-off timer of the access point to be a first back-off time value, wherein the first back-off time value is less than a second back-off time value of any on board unit (OBU) which receives the traffic event packet; and
broadcasting the traffic event packet by the access point when the back-off timer is counted down to be zero.

2. The controlling method of the access point in the geographic routing system according to claim 1, wherein the first back-off time value is zero.

3. The controlling method of the access point in the geographic routing system according to claim 1, further comprising:
setting a transmitting power of the access point to be a first transmitting power value, wherein the first transmitting power value is larger than a second transmitting power value of any OBU.

4. A controlling method of an access point in a geographic routing system, comprising:
receiving a traffic event packet by the access point; and
determining whether there is another access point which is closer to a destination area than the access point;
forwarding the traffic event packet to the another access point, if there is the another access point which is closer to the destination area than the access point; and
broadcasting the traffic event packet by the access point.

5. The controlling method of the access point in the geographic routing system according to claim 4, further comprising:
freezing the back-off timer and throw the back-off timer away, if there is the another access point which is closer to the destination area than the access point.

6. The controlling method of the access point in the geographic routing system according to claim 4, further comprising:
broadcasting the traffic event packet to any on board unit (OBU) and setting a hop limit value to be 1, if there is the another access point which is closer to the destination area than the access point.

7. An access point in a geographic routing system, comprising:
a transmitter for receiving a traffic event packet; and
a processor setting a back-off timer of the access point to be a first back-off time value, wherein the first back-off time value is less than a second back-off time value of any on board unit (OBU) which receives the traffic event packet and the transmitter transmits the traffic event packet when the back-off timer of the access point is counted down to be zero.

8. The access point in the geographic routing system according to claim 7, wherein the first back-off time value is zero.

9. The access point in the geographic routing system according to claim 7, wherein the processor further sets a transmitting power of the access point to be a first transmitting power value, and the first transmitting power value is larger than a second transmitting power value of any OBU.

10. An access point in a geographic routing system, comprising:
a transmitter for receiving a traffic event packet and transmitting the traffic event packet when a back-off timer of the access point is counted down to be zero; and
a location provider for providing a location of the access point; and
a processor for determining whether there is another access point which is closer to a destination area than the access point according to the location of the access point, wherein the transmitter forwards the traffic event packet to the another access point, if there is the another access point which is closer to the destination area than the access point.

11. The access point in the geographic routing system according to claim 10, wherein the transmitter freeze the back-off timer and throw the back-off timer away, if there is the another access point which is closer to the destination area than the access point.

12. The access point in the geographic routing system according to claim 10, wherein the transmitter broadcasts the traffic event packet and the processor sets a hop limit value to be 1 if there is the another access point which is closer to the destination area than the access point.
